(19) United States
(12) Patent Application Publication
(10) Pub. No.: US 2020/0230708 A1
(43) Pub. Date: Jul. 23, 2020

(54) ROTARY CUTTING TOOL

(71) Applicant: A.L.M.T. Corp., Tokyo (JP)

(72) Inventors: Yuma MIYAZAKI, Kato-shi (JP); Kentaro SHIRO, Kato-shi (JP)

(73) Assignee: A.L.M.T. Corp., Tokyo (JP)

(21) Appl. No.: 16/647,536

(22) PCT Filed: Sep. 18, 2018
(86) PCT No.: PCT/JP2018/034361

§ 371 Date: Mar. 16, 2020

(30) Foreign Application Priority Data
Oct. 12, 2017 (JP) 2017-198193

(51) Int. Cl. B23B 27/16

(52) U.S. Cl. CPC B23B 27/16

(57) ABSTRACT

An outer peripheral cutting edge located on a rear side in a rotation axis direction of the inclined cutting edge, a rotation diameter of the base metal on the rear side in the rotation axis direction of the outer peripheral cutting edge is smaller than a rotation diameter of the outer peripheral cutting edge, in a cross section perpendicular to a direction in which the inclined cutting edge extends, a cutting edge ridge of the inclined cutting edge has a roundness of a radius less than or equal to 30 μm, and a maximum height difference value of the cutting edge ridge of the inclined cutting edge is less than or equal to 20 μm.

### TECHNICAL FIELD

This invention relates to a rotary cutting tool. This application claims priority based on Japanese Patent Application No. 2017-198193, which is a Japanese patent application filed on Oct. 12, 2017. All the descriptions given in the Japanese patent application are incorporated herein by reference.

### BACKGROUND ART

Conventionally, a rotary cutting tool has been disclosed in, for example, Japanese Patent Laying-Open No. 2002-144145 (PTL 1).

### CITATION LIST

### Patent Literature

PTL 1: Japanese Patent Laying-Open No. 2002-144145

### SUMMARY OF INVENTION

A rotary cutting tool according to one aspect of this invention includes a base metal and a plurality of PCBN tips provided on an outer periphery of the base metal. Each of the plurality of PCBN tips has an inclined cutting edge located at an outer peripheral forefront and forming an angle greater than or equal to 20° and less than or equal to 80° with respect to a rotation axis, and an outer peripheral cutting edge located on a rear side in a rotation axis direction of the inclined cutting edge, a rotation diameter of the base metal on the rear side in the rotation axis direction of the outer peripheral cutting edge is smaller than a rotation diameter of the outer peripheral cutting edge, in a cross section perpendicular to a direction in which the inclined cutting edge extends, a cutting edge ridge of the inclined cutting edge has a roundness of a radius less than or equal to 30 μm, and a maximum height difference value of the cutting edge ridge of the inclined cutting edge is less than or equal to 20 μm.

### BRIEF DESCRIPTION OF DRAWINGS

FIG. 1 is a front view of a rotary cutting tool according to a first embodiment.

FIG. 2 is an enlarged view of the rotary cutting tool in a portion surrounded by II in FIG. 1.

FIG. 3 is a side view of the rotary cutting tool viewed from a direction indicated by arrow III in FIG. 2.

FIG. 4 is a cross-sectional view along line IV-IV in FIG. 2.

FIG. 5 is a front view of a part of a rotary cutting tool according to a second embodiment.

FIG. 6 is a cross-sectional view along line VI-VI in FIG. 5.

FIG. 7 is a cross-sectional view of a tip of a rotary cutting tool according to a third embodiment.

FIG. 8 is a front view of a part of a rotary cutting tool according to a fourth embodiment.

FIG. 9 is a front view of a rotary cutting tool according to a fifth embodiment.

FIG. 10 is an enlarged view of the rotary cutting tool in a portion surrounded by X in FIG. 9.

FIG. 11 is a side view of the rotary cutting tool viewed from a direction indicated by arrow XI in FIG. 10.

FIG. 12 is a front view of a part of a rotary cutting tool according to a sixth embodiment.

FIG. 13 is a view for describing a method of measuring a maximum height difference value.

FIG. 14 is a view for describing an inclined flank surface, a second flank surface, and clearance angles thereof.

### DETAILED DESCRIPTION

### Problem to be Solved by the Present Disclosure

The conventional technique has a problem that high-precision machining is difficult. Accordingly, this invention has been made to solve the above-described problem, and an object of the present invention is to provide a rotary cutting tool capable of high-precision machining.

### Description of Embodiments

Embodiments of the present invention will be described.

A rotary cutting tool according to each of the embodiments is mainly a rotary cutting tool (PCBN reamer) for machining a finishing hole in cast iron or iron-based sintered alloys. In machining of materials such as cast iron, iron-based sintered alloys, and the like, while a rotating tool that uses a cemented carbide as a cutting edge material and is provided with a cemented carbide guide pad is used, in order to enhance durability, PCBN with a high heat resistance and a chemical wear resistance is sometimes used as the cutting edge material.

While when high-precision machining is aimed at with a conventional reamer, it is normal to provide a cemented carbide guide pad, there are the following problems in machining of materials such as cast iron, iron-based sintered alloys and the like.

(1) Chips are deposited on a guide pad portion. While in the machining of a material such as an aluminum alloy or the like, flow-type chips are generated, in the machining of cast iron, iron-based sintered alloys and the like, granular chips are generated in addition to flow-type chips, and enter a gap between a machining surface and a guide pad, so that a machining surface accuracy deteriorates. In addition, deposition of the chips frequently occurs on the tool.

(2) Machining surface roughness deteriorates due to the deposition.

(3) The machining surface roughness easily varies from beginning of machining, and a required accuracy is frequently not satisfied. A direct cause thereof is that there is irregular micro-chipping on a biting cutting edge.

While in order to avoid the above problems, it is necessary to eliminate the guide pad, high-precision machining cannot be performed. In consideration of the above-described cause, the present inventor has intensively studied a rotary cutting tool capable of performing highly accurate machining without providing a guide pad. As a result, a rotary cutting tool having the following configurations has been found.

Configuration (A): A polycrystalline cubic boron nitride sintered body (PCBN) is used as a material for a cutting edge tip.

Configuration (B): Two or more cutting edge tips are provided.

Configuration (C): A guide pad of cemented carbide, diamond or the like separate from the cutting edge tip is not provided. A margin immediately on a rear side in a rotational direction of a cutting edge ridge provided in the cutting edge tip may be provided.

Configuration (D): A diameter of a base metal on a rear side in an axial direction of an outer peripheral cutting edge is made smaller than an outer peripheral cutting edge rotation diameter.

Configuration (E): At least an outer peripheral portion of a forefront cutting edge has an inclination angle θ1 with respect to a diametrical direction, and is an inclined cutting edge whose inclination angle θ1 is 20° to 80° with respect to a rotation axis. The entire forefront cutting edge may be the inclined cutting edge.

Configuration (F1): A cross-sectional shape of a cutting edge ridge of the inclined cutting edge is an arc shape (round honing) (including a sharp wedge shape) having a radius r less than or equal to 30 μm.

Configuration (F2): Instead of configuration (F1), a chamfer honing is provided, and this chamfer angle is −5° to −25° with respect to a rake surface.

Configuration (G): Unevenness of the cutting edge ridge, that is, a maximum height difference value of the cutting edge ridge is less than or equal to 20 μm. Obviously, unevenness of the cutting edge ridge with the honing formed is also less than or equal to 20 μm.

The present inventor has found the following configuration as a rotary cutting tool having a different configuration from this. The rotary cutting tool includes the above-described configurations (A) to (D) and (G). Further, the rotary cutting tool has the following configurations.

Configuration (H): Instead of the inclined cutting edge of the above-described configuration (E), an R cutting edge (biting cutting edge, curved cutting edge) is provided at a boundary between the forefront cutting edge and the outer peripheral cutting edge.

Configuration (I1): The cross-sectional shape of the cutting edge ridge of the curved cutting edge is a sharp wedge shape or an arc shape having radius r less than or equal to 11 μm (round honing).

Configuration (I2): Instead of configuration (I1), chamfer honing is provided, and this angle is −5° to −25° with respect to the rake surface.

A maximum height difference value of the cutting edge ridge of the outer peripheral cutting edge may be less than or equal to 20 μm.

A difference between a base metal diameter on the rear side in the axial direction of the outer peripheral cutting edge and the rotation diameter of the outer peripheral cutting edge is greater than or equal to 0.01 mm, and the diameter of the base metal on the rear side in the axial direction of the outer peripheral cutting edge may be greater than or equal to 50% of the rotation diameter of the outer peripheral cutting edge.

A width W of a chamfered surface may be 0.05 mm to 0.3 mm.

Grooves may be provided in the base metal, and two holes for coolant may be provided for each of the grooves.

A length in the rotation axis direction of the outer peripheral cutting edge may be greater than or equal to 2 mm.

A cutting condition may be such that a peripheral speed V is higher than or equal to 100 m/min and lower than or equal to 300 m/min in the rotary cutting tool provided with the inclined cutting edges on the forefront outer periphery. In the rotary cutting tool provided with the curved cutting edges on the forefront outer periphery, peripheral speed V may be lower than or equal to 100 m/min.

In the above-described rotary cutting tools, even if there is no guide pad, it has a good cutting quality and rotates stably, so that the machining surface can be machined with high accuracy.

In finishing machining of cast iron, iron-based sintered alloys, and the like, chipping of the cutting edge is hard to occur, and a tool life is extended with little wear.

Since chip deposition onto the cutting edges or the base metal does not occur, it is possible to prevent the machining surface roughness from deteriorating. In addition, cutting edge breakage is also hard to occur, and the tool life is extended.

The above effects result in the tool life about five times longer than that of a cemented carbide rotary cutting tool.

Theoretical endorsement for obtaining a high-performance rotary cutting tool by employing the above-described configuration is not necessarily clear. The performance is considered to be enhanced for the following reasons.

Although PCBN is used for the cutting edges to enhance the tool life, in the machining of cast iron, iron-based sintered alloys, and the like, mainly using PCBN, granular chips are generated, and the chips enter a gap between the machining surface and the guide pad, so that unlike applications where diamond cutting edges are used, chips are easily deposited on the guide pad made of a cemented carbide alloy.

For this reason, no guide pad made of a cemented carbide alloy is provided to reduce the chip deposition, and further, the base metal diameter behind the outer peripheral cutting edge is made smaller than the cutting edge diameter. This prevents contact with an inner surface of a machined hole and prevents deposition to enhance machining surface accuracy.

While since no guide pad is provided, the tool easily sways and vibrates during machining, the number of the cutting edges is made greater than or equal to two, and further, by using sharp cutting edges, the cutting quality is enhanced to suppress the sway and the vibration.

In order to make it hard for the tool to sway or vibrate during machining, the inclined cutting edge is provided at a biting portion on an outer peripheral side of a forefront of the cutting edge. In order to enhance the cutting quality of this inclined cutting edge, the cross-sectional shape of the inclined cutting edge (the surface perpendicular to the cutting edge ridge is defined as a cross section) is an arc shape with radius r less than or equal to 30 μm (including a sharp wedge shape) at the cutting edge ridge portion.

Machining accuracy is enhanced by reducing the unevenness of the cutting edge ridge of the inclined cutting edge. In addition, by making the unevenness small, chipping of the cutting edge is harder to occur, good machining accuracy can be maintained for a long time, and the tool life is extended.

Even if the chamfered surface is provided on the cutting edge ridge of the inclined cutting edge, the above effect can be realized. However, for this, a chamfer angle θ2 of the chamfered surface is set to −5° to −25° with respect to the rake surface. This is because as the angle becomes larger, a cutting resistance becomes larger, so that there is a risk that the cutting quality deteriorates.

Note that “there is a risk” indicates that there is a slight possibility that this will occur, and it does not mean that it will occur with a high probability. Preferably, width W of the chamfered surface is 0.05 mm to 0.3 mm.

In the machining of cast iron, iron-based sintered alloys and the like, particulate chips called sludge are partially generated. When this sludge is caught in the gap between the machining surface and the guide pad, deposition occurs and the machining surface roughness decreases.

Considering a size of the sludge, the base metal radius should be smaller by 0.01 mm or more than the outer peripheral cutting edge radius so that the chips flow smoothly.

Further, if a gap of 50% or more of the cutting edge radius is provided, the base metal diameter becomes small and tool rigidity is extremely lowered, and thus, the base metal diameter is set to 50% or more of the cutting edge diameter. However, since it is sufficient if the size of the gap is about 0.5 mm, it is preferable to set the gap to 0.5 mm or less in consideration of the tool rigidity.

In reamer machining, since a large load is applied to the cutting edge at an entrance of the hole to be machined, the breakage of the cutting edge can be further prevented by increasing a PCBN content rate of the PCBN cutting edge tip. In a reamer in which the inclined cutting edge with the straight biting portion is formed, a chip thickness becomes thinner and the cutting resistance becomes lower by increasing a cutting speed, so that it is preferable that peripheral speed V of the outer peripheral cutting edge is 100 m/min to 300 m/min, which is high-speed cutting. Further, in a reamer in which the biting portion is the curved cutting edge, chatter is generated as the cutting speed becomes higher, and thus, it is preferable that peripheral speed V of the outer peripheral cutting edge is lower than or equal to 100 m/min, which is a lower cutting speed.

By a method of increasing the number of coolant holes, enlarging the coolant holes, increasing a coolant supply pressure, or the like, a coolant supply amount is increased to thereby efficiently discharge the chips, which is also effective for improving the effects. In particular, by supplying the coolant to two portions of the biting portion (the inclined cutting edge and the curved cutting edge) and the outer peripheral cutting edge, the discharge of chips can be enhanced, and accumulation and deposition can be prevented.

In the rotary cutting tool of Patent Literature 1 (Japanese Patent Laying-Open No. 2002-144145), the inclined cutting edge and the curved cutting edge in the present embodiments are not disclosed. These configurations are important, and these configurations exhibit the above-described effects.

A rotary cutting tool according to one embodiment of this invention includes: a base metal; and a plurality of PCBN tips provided on an outer periphery of the base metal, wherein each of the plurality of PCBN tips has an inclined cutting edge located at an outer peripheral forefront and forming an angle greater than or equal to 20° and less than or equal to 80° with respect to a rotation axis, and an outer peripheral cutting edge located on a rear side in a rotation axis direction of the inclined cutting edge, a rotation diameter of the base metal on the rear side in the rotation axis direction of the outer peripheral cutting edge is smaller than a rotation diameter of the outer peripheral cutting edge, in a cross section perpendicular to a direction in which the inclined cutting edge extends, a cutting edge ridge of the inclined cutting edge has a roundness of a radius less than or equal to 30 μm, and a maximum height difference value of the cutting edge ridge of the inclined cutting edge is less than or equal to 20 μm.

A rotary cutting tool according to another embodiment of this invention includes: a base metal; and a plurality of PCBN tips provided on an outer periphery of the base metal, wherein each of the plurality of PCBN tips has an inclined cutting edge located at an outer peripheral forefront and forming an angle greater than or equal to 20° and less than or equal to 80° with respect to a rotation axis, and an outer peripheral cutting edge located on a rear side in a rotation axis direction of the inclined cutting edge, a rotation diameter of the base metal on the rear side in the rotation axis direction of the outer peripheral cutting edge is smaller than a rotation diameter of the outer peripheral cutting edge, in each of the plurality of PCBN tips, a chamfered surface chamfered so as to be adjacent to the inclined cutting edge is formed, and the chamfered surface forms an angle of −5° to −25° with respect to a rake surface, and a maximum height difference value of a cutting edge ridge of the inclined cutting edge is less than or equal to 20 μm.

A rotary cutting tool according to another embodiment of this invention includes: a base metal; and PCBN tips provided on an outer periphery of the base metal, wherein each of the PCBN tips has an outer peripheral cutting edge, a front cutting edge, and a curved cutting edge located between the outer peripheral cutting edge and the front cutting edge, a rotation diameter of the base metal on a rear side in a rotation axis direction of the outer peripheral cutting edge is smaller than a rotation diameter of the outer peripheral cutting edge, in a cross section perpendicular to a direction in which the curved cutting edge extends, a cutting edge ridge of the curved cutting edge has a roundness of a radius less than or equal to 11 μm, and a maximum height difference value of the cutting edge ridge of the curved cutting edge is less than or equal to 20 μm.

A rotary cutting tool according to another embodiment of this invention includes: a base metal; and PCBN tips provided on an outer periphery of the base metal, wherein in each of the PCBN tips, a chamfered surface chamfered between a rake surface and a flank surface is formed, the PCBN tip has an outer peripheral cutting edge, a front cutting edge, and a curved cutting edge located between the outer peripheral cutting edge and the front cutting edge, a rotation diameter of the base metal on a rear side in a rotation axis direction of the outer peripheral cutting edge is smaller than a rotation diameter of the outer peripheral cutting edge, in a cross section perpendicular to a direction in which the curved cutting edge extends, a cutting edge ridge of the curved cutting edge has a roundness of a radius less than or equal to 11 μm, and a maximum height difference value of the cutting edge ridge of the curved cutting edge is less than or equal to 20 μm.

### First Embodiment

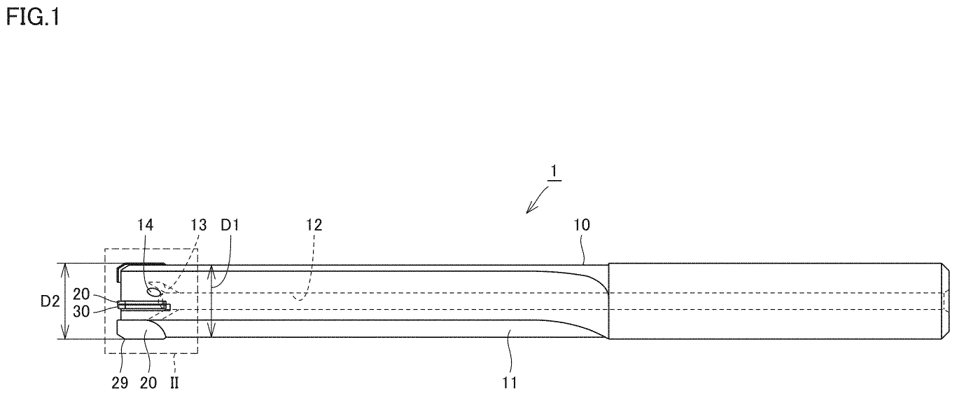

FIG. 1 is a front view of a rotary cutting tool according to a first embodiment. As shown in FIG. 1, a rotary cutting tool 1 is a reamer. Rotary cutting tool 1 has base metal 10.

Base metal 10 extends in a longitudinal direction. Tips 20 are provided at a forefront portion of base metal 10. Base metal 10 is provided with grooves 11 extending in the longitudinal direction. Tips 20 are disposed inside grooves 11.

Base metal 10 is made of, for example, a steel or a cemented carbide alloy. Tips 20 are fixed to base metal 10 by brazing. While in this embodiment, each of tips 20 is directly fixed to base metal 10, tip 20 may be fixed to a base seat different from tip 20 by brazing, and the base seat may be fixed to base metal 10 by brazing or bolts.

Each of Tips 20 is configured of a PCBN tip 29 made of, for example, PCBN (polycrystalline cubic boron nitride sintered body), and a base seat 30 as a base for holding PCBN tip 29.

Base metal 10 is provided with a coolant passage 12. Coolant passage 12 extends inside base metal 10 along the longitudinal direction of base metal 10 and is connected to holes 13 for supplying a coolant to a contact interface between PCBN tip 29 and a workpiece. Base metal 10 is provided with openings 14 each connected to hole 13.

While in this embodiment, four tips 20 are provided on base metal 10, a plurality of tips 20, of which number is greater than or less than four, may be provided on base metal 10. The plurality of tips 20 are provided on the same circumferential track. Further, the plurality of tips 20 may be provided on base metal 10 in a plurality of stages in the axial direction of base metal 10.

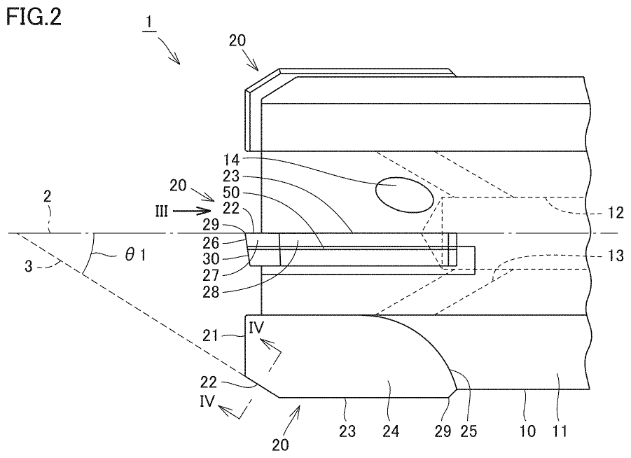

FIG. 2 is an enlarged view of the rotary cutting tool in a portion surrounded by II in FIG. 1. As shown in FIG. 2, each of PCBN tips 29 configuring the tips 20 is composed of a front cutting edge 21, an inclined cutting edge 22 located at an outer peripheral forefront so as to be connected to front cutting edge 21, and an outer peripheral cutting edge 23 connected to inclined cutting edge 22. A region surrounded by front cutting edge 21, inclined cutting edge 22, and outer peripheral cutting edge 23 is a rake surface 24.

In this embodiment, front cutting edge 21 extends so as to be substantially orthogonal to outer peripheral cutting edge 23. However, front cutting edge 21 may have an inclination angle with respect to outer peripheral cutting edge 23. The inclination angle is an angle formed by front cutting edge 21 with respect to a rotation axis 2.

Inclined cutting edge 22 forms an inclination angle θ1 with respect to rotation axis 2. Inclination angle θ1 is an angle formed by a dotted line 3 obtained by extending linear inclined cutting edge 22, and rotation axis 2. When dotted line 3 and rotation axis 2 intersect, inclination angle θ1 is an angle at an intersecting portion. When dotted line 3 and rotation axis 2 do not intersect but are in a twisted position, inclination angle θ1 is an angle at an intersecting portion when dotted line 3 is moved in parallel and rotation axis 2 intersects with dotted line 3. A curved rear end 25 is provided on a rear side of PCBN tip 29. An outer diameter of outer peripheral cutting edge 23 is larger than the outer diameter of base metal 10.

Inclination angle θ1 is greater than or equal to 20°, and less than or equal to 80°. Inclined cutting edge 22 has a function of expanding a hole of the workpiece. When inclination angle θ1 is less than 20°, inclined cutting edge 22 is substantially parallel to outer peripheral cutting edge 23, and a force that inclined cutting edge 22 receives in a radial direction from the workpiece is increased, thereby facilitating chatter. When inclination angle θ1 exceeds 80°, an intersection of inclined cutting edge 22 and outer peripheral cutting edge 23 is easily broken.

A brazing material layer 50 is provided between PCBN tip 29 and base seat 30. PCBN tip 29 may be fixed to base seat 30 by means other than brazing material layer 50, for example, sintering.

PCBN tip 29 has a front flank surface 26, an inclined flank surface 27, and an outer peripheral flank surface 28. These become the flank surfaces of PCBN tip 29. Front flank surface 26 is adjacent to front cutting edge 21. Inclined flank surface 27 is adjacent to inclined cutting edge 22. Outer peripheral flank surface 28 is adjacent to outer peripheral cutting edge 23.

A margin may be formed on a rear side in a rotational direction of outer peripheral cutting edge 23 and on a front side in the rotational direction of outer peripheral flank surface 28 so as to extend along outer peripheral cutting edge 23. The margin is a portion that comes into contact with the workpiece in rotary cutting. Outer peripheral flank surface 28 is a portion that does not come into contact with the workpiece in rotary cutting. The margin may be formed only by PCBN tip 29. The margin may be made of PCBN tip 29 and base seat 30.

A rotation diameter D1 (FIG. 1) of base metal 10 on the rear side in the rotation axis 2 direction of outer peripheral cutting edge 23 is smaller than a rotation diameter D2 (FIG. 1) of outer peripheral cutting edge 23.

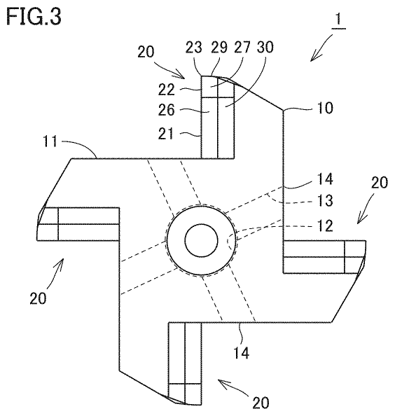

FIG. 3 is a side view of the rotary cutting tool viewed from the direction indicated by arrow III in FIG. 2. As shown in FIG. 3, holes 13 are provided radially outward from coolant passage 12 of base metal 10. A forefront of each of holes 13 is opening 14. Opening 14 is provided on the front side in the rotational direction of front cutting edge 21 and inclined cutting edge 22. The coolant ejected from opening 14 is supplied to a portion where front cutting edge 21 and the like come into contact with the workpiece.

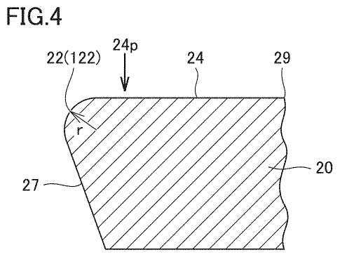

FIG. 4 is a cross-sectional view along line IV-IV in FIG. 2. As shown in FIG. 4, in PCBN tip 29, inclined cutting edge 22 is between rake surface 24 and inclined flank surface 27. In the cross section shown in FIG. 4, inclined cutting edge 22 has an arc shape with a radius r. This arc is formed by honing.

In the cross section perpendicular to a direction in which inclined cutting edge 22 extends, a cutting edge ridge of inclined cutting edge 22 has roundness with a radius r less than or equal to 30 μm, and a maximum height difference value of the cutting edge ridge of inclined cutting edge 22 is less than or equal to 20 μm.

The “maximum height difference value” can be measured, for example, by observation at 500 times with a microscope manufactured by KEYENCE. Hereinafter, the maximum height difference value is also simply referred to as a “PV value”.

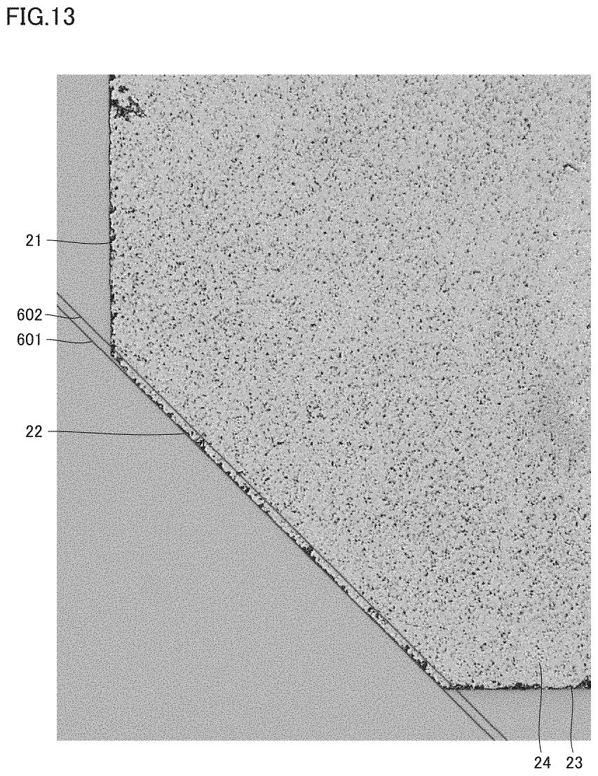

FIG. 13 is a view for describing a method for measuring the maximum height difference value. When the ridge of inclined cutting edge 22 is viewed from a direction perpendicular to rake surface 24 (direction indicated by an arrow 24p in FIG. 4), an image as shown in FIG. 13 is obtained. With reference to a straight line 601 that connects outermost peak portions of inclined cutting edge 22, a straight line 602 passing a concave portion of inclined cutting edge 22 that is parallel to straight line 601 and is located on an innermost side is drawn. A distance between straight line 601 and straight line 602 is the PV value.

If radius r exceeds 30 μm, inclined cutting edge 22 becomes unsharp and cutting quality deteriorates. If the PV value exceeds 20 μm, a surface roughness of the workpiece decreases, and high-precision cutting becomes difficult.

### Second Embodiment

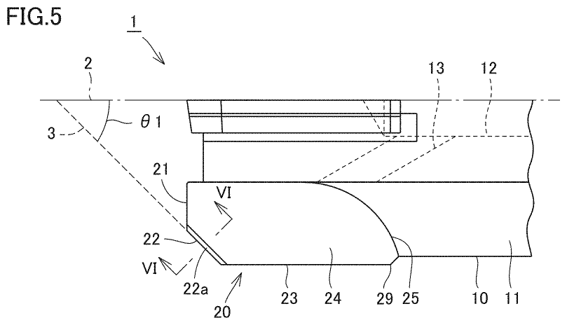

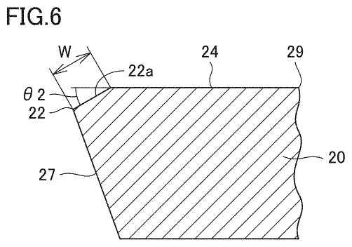

FIG. 5 is a front view of a part of a rotary cutting tool according to a second embodiment. FIG. 6 is a cross-sectional view along line VI-VI in FIG. 5. As shown in FIGS. 5 and 6, a rotary cutting tool 1 according to the second embodiment is different from rotary cutting tool 1 according to the first embodiment in that each of PCBN tips 29 is provided with a chamfered surface 22a formed by chamfering.

That is, rotary cutting tool 1 includes a base metal 10 and a plurality of PCBN tips 29 provided on an outer periphery of base metal 10, and each of the plurality of PCBN tips 29 includes an outer peripheral cutting edge 23, a front cutting edge 21, and an inclined cutting edge 22 that is located between outer peripheral cutting edge 23 and front cutting edge 21 and forms an inclination angle θ1 greater than or equal to 20°, and less than or equal to 80° with respect to a rotation axis 2.

A rotation diameter of base metal 10 on a rear side of outer peripheral cutting edge 23 in a rotation axis 2 direction is smaller than a rotation diameter of outer peripheral cutting edge 23, and each of PCBN tips 29 is formed with chamfered surface 22a that is chamfered so as to be adjacent to inclined cutting edge 22 located at an outer peripheral forefront, and a maximum height difference value of a cutting edge ridge of inclined cutting edge 22 is less than or equal to 20 μm. A chamfer angle θ2 formed by chamfered surface 22a with respect to a rake surface 24 is −5° to −25° . A width W of chamfered surface 22a may be 0.05 mm to 0.3 mm.

### Third Embodiment

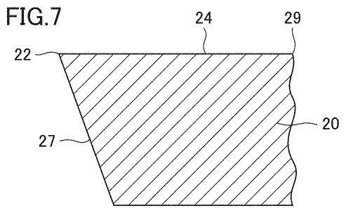

FIG. 7 is a cross-sectional view of a tip of a rotary cutting tool according to a third embodiment. FIG. 7 corresponds to a cross-sectional view along line IV-IV in FIG. 2. As shown in FIG. 7, a ridge of an inclined cutting edge 22 of each of PCBN tips 29 according to the third embodiment has a sharp shape with a radius r of substantially zero in a cross section thereof. Above-described inclined cutting edge 22 also has a roundness with a radius r less than or equal to 30 μm.

### Fourth Embodiment

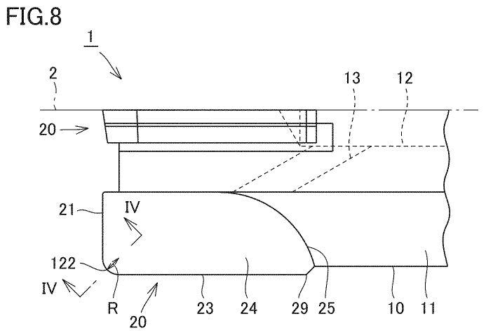

FIG. 8 is a front view of a part of a rotary cutting tool according to a fourth embodiment. A cross section along line IV-IV in FIG. 8 corresponds to FIG. 4. Rotary cutting tool 1 according to the fourth embodiment includes a base metal 10 and a plurality of PCBN tips 29 provided on an outer periphery of base metal 10, and each of the plurality of PCBN tips 29 includes an outer peripheral cutting edge 23, a front cutting edge 21, and a curved cutting edge 122 located between outer peripheral cutting edge 23 and front cutting edge 21. A rotation diameter of base metal 10 on a rear side in a rotation axis 2 direction of outer peripheral cutting edge 23 is smaller than a rotation diameter of outer peripheral cutting edge 23. In a cross section perpendicular to an extending direction of curved cutting edge 122, a cutting edge of the curved cutting edge 122 has a roundness with a radius r less than or equal to 11 μm, and a maximum height difference value of the cutting edge ridge of curved cutting edge 122 is less than or equal to 20 μm. A radius of curved cutting edge 122 in a rake surface 24 is R. There is no particular limitation on a size of radius R. The size of Radius R may be any dimension that smoothly connects front cutting edge 21 and outer peripheral cutting edge 23. Curved cutting edge 122 may have an arc shape, an elliptical arc shape, or a shape having a plurality of curvatures.

As compared with linear inclined cutting edge 22 of the first embodiment, curved cutting edge 122 at an outer peripheral forefront is curved. As a result, in order to obtain a similar cutting quality to that of linear inclined cutting edge 22, it is necessary to make radius r smaller. Therefore, by setting radius r to 11 μm to make a cross section sharper, biting to the workpiece is enhanced and cutting quality is enhanced.

More specifically, chatter easily occurs when a cutting speed is increased with curved cutting edge 122, and therefore, low-speed machining conditions are suitable. In the case of low speed machining, a machining surface becomes clouded if the cutting quality is poor. Therefore, in order to enhance the cutting quality, the roundness radius is made smaller than that of the linear inclined cutting edge.

### Fifth Embodiment

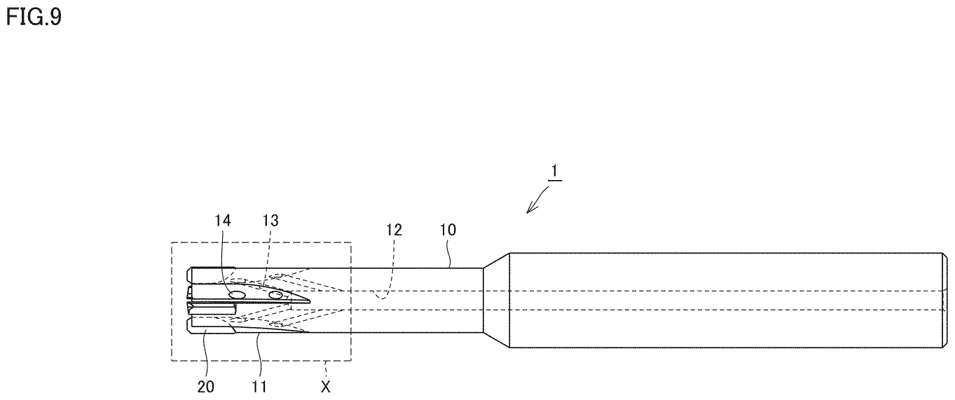

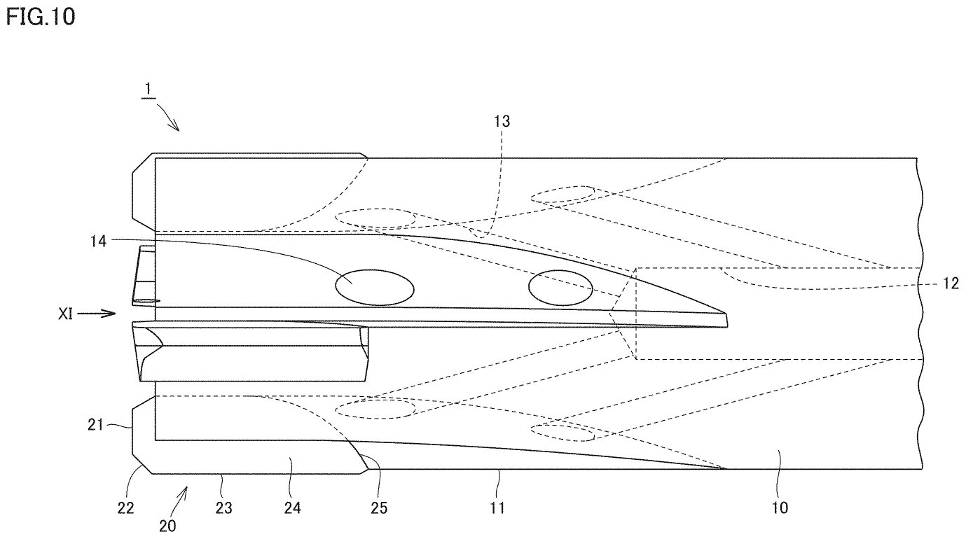

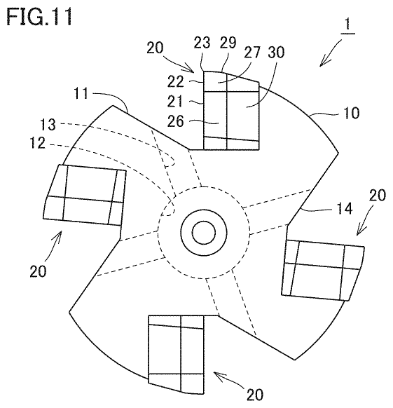

FIG. 9 is a front view of a rotary cutting tool according to a fifth embodiment. FIG. 10 is an enlarged view of the rotary cutting tool in a portion surrounded by X in FIG. 9. FIG. 11 is a side view of the rotary cutting tool viewed from a direction indicated by arrow XI in FIG. 10.

A rotary cutting tool 1 according to the fifth embodiment is different from rotary cutting tool 1 in the first embodiment in which four tips 20 are arranged at even intervals on the outer periphery of base metal 10 in that four tips 20 are arranged at uneven intervals on an outer periphery of a base metal 10. Furthermore, in rotary cutting tool 1 of the fifth embodiment, two openings 14 are provided in one groove 11. Opening 14 on a forefront side mainly supplies a coolant to a front cutting edge 21 and an inclined cutting edge 22, and opening 14 on a rear end side mainly supplies the coolant to an outer peripheral cutting edge 23.

### Sixth Embodiment

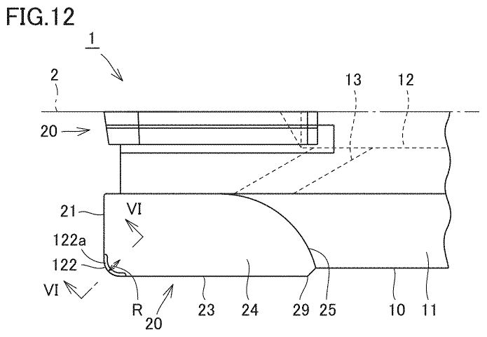

FIG. 12 is a front view of a part of a rotary cutting tool according to a sixth embodiment. A cross section along line VI-VI in FIG. 12 corresponds to FIG. 6. A rotary cutting tool 1 according to the sixth embodiment includes a base metal 10 and a plurality of PCBN tips 29 provided on an outer periphery of base metal 10. The plurality of PCBN tips 29 have an outer peripheral cutting edge 23, a front cutting edge 21, and a curved cutting edge 122 located between outer peripheral cutting edge 23 and front cutting edge 21. A rotation diameter of base metal 10 on a rear side in a rotation axis 2 direction of outer peripheral cutting edge 23 is smaller than a rotation diameter of outer peripheral cutting edge 23. PCBN tips 29 are each formed with a chamfered surface 122a chamfered so as to be adjacent to curved cutting edge 122. Chamfered surface 122a forms an angle of −5° to −25° with respect to rake surface 24, and a maximum height difference value of a cutting edge ridge of curved cutting edge 122 is less than or equal to 20 μm.

### Details of the Embodiments of the Present Invention

### Example

(1) Verification of Inclined Cutting Edge 22

(1-1) Verification of Inclination Angle θ1

The plurality of rotary cutting tools 1 in each of which two tips 20 were provided on base metal 10 of the first embodiment (FIGS. 1 to 4) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Roundness radius r formed by honing was 10 μm. Each of the plurality of rotary cutting tools 1 had the following inclination angle θ1 and PV value.

TABLE 1

| | Inclination angle θ1(°) | PV value (μm) |
|---|---|---|
| Comparative Example 1 | 85 | 5 |
| Example 1 | 80 | 8 |
| Example 2 | 45 | 7 |
| Example 3 | 20 | 6 |
| Comparative Example 2 | 15 | 10 |

Cutting tests were performed using the above rotary cutting tools. The cutting condition was such that peripheral speed V of outer peripheral cutting edge 23 was 200 m/min. This is high-speed cutting. A feed amount was 0.05 mm/rev. The workpiece was an iron-based sintered alloy. A prepared hole diameter was 5.8 mm. A machining allowance was 0.2 mm per diameter. The surface roughness of the workpiece after cutting is shown below. The surface roughness of the workpiece was measured with a surface roughness measuring machine (SURFCOM manufactured by TOKYO SEIMITSU).

TABLE 2

| | Workpiece surface | |
|---|---|---|
| | roughness (μmRz) | Remarks |
| Comparative Example 1 | 6.7 | Inclined cutting edge |
| | | ridge was broken |
| Example 1 | 2.1 | |
| Example 2 | 1.4 | |
| Example 3 | 3.7 | |
| Comparative Example 2 | 7.8 | Chatter occurred |

From Table 2, it has been found that if inclination angle θ1 is greater than or equal to 20° and less than or equal to 80°, a preferable surface roughness can be obtained and high-precision cutting can be performed.

(1-2) Verification of Chamfer Angle θ2

The plurality of rotary cutting tools 1 in each of which two tips 20 were provided on base metal 10 of the second embodiment (FIGS. 5 and 6) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Inclination angle θ1 was 45°. Width W of the chamfered surface 22a formed by honing was set to 0.1 mm. Each of the plurality of rotary cutting tools 1 had the following chamfer angle θ2 and PV value.

TABLE 3

| | Chamfer angle θ2(°) | PV value (μm) |
|---|---|---|
| Comparative Example 11 | −4 | 2 |
| Example 11 | −5 | 1 |
| Example 12 | −10 | 1 |
| Example 13 | −15 | 2 |
| Example 14 | −20 | 3 |
| Example 15 | −25 | 1 |
| Comparative Example 12 | −30 | 1 |

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter. The surface roughness of the workpiece after cutting is shown below.

TABLE 4

| | Workpiece surface | |
|---|---|---|
| | roughness (μmRz) | Remarks |
| Comparative Example 11 | 8.3 | Since a chamfer resistance |
| | | increased, breakage occurred |
| | | at the inclined cutting edge |
| | | ridge. |
| Example 11 | 3.8 | |
| Example 12 | 4.1 | |
| Example 13 | 4.3 | |
| Example 14 | 4.2 | |
| Example 15 | 5.4 | |
| Comparative Example 12 | 10.2 | Deposition and chatter occurred |

From Table 4, it has been found that if chamfer angle θ2 is −5° to −25°, a preferable surface roughness can be obtained and high-precision cutting can be performed.

(1-3) Verification of Radius r

The plurality of rotary cutting tools 1 in each of which two tips 20 were provided on base metal 10 of the first embodiment (FIGS. 1 to 4) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Inclination angle θ1 was 45°. Each of the plurality of rotary cutting tools 1 had the following roundness radius r and PV value (μm) formed by honing.

TABLE 5

| | Radius r (μm) | PV value (μm) |
|---|---|---|
| Comparative Example 21 | 35 | 1 |
| Example 21 | 30 | 2 |
| Example 22 | 20 | 2 |
| Example 23 | 10 | 1 |

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter. The surface roughness of the workpiece after cutting is shown below.

TABLE 6

| | Workpiece surface roughness (μmRz) |
|---|---|
| Comparative | 7.2 |
| Example 21 | |
| Example 21 | 4.3 |
| Example 22 | 2.8 |
| Example 23 | 1.4 |

From Table 6, it has been found that if radius r of the roundness is less than or equal to 30 μm, a preferable surface roughness can be obtained and high-precision cutting can be performed.

(1-4) Verification of PV Value

The plurality of rotary cutting tools 1 in each of which two tips 20 were provided on base metal 10 of the third embodiment (FIGS. 1, 2, 3, and 7) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Inclination angle θ1 was 45°. Roundness radius r formed by honing was 20 μm. Each of the plurality of rotary cutting tools 1 had the following PV value at the cutting edge ridge of inclined cutting edge 22.

TABLE 7

| | PV value (μm) |
|---|---|
| Comparative Example 31 | 25 |
| Example 31 | 20 |
| Example 32 | 10 |
| Example 33 | 5 |

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter. The surface roughness of the workpiece after cutting is shown below.

TABLE 8

| | Workpiece surface | |
|---|---|---|
| | roughness (μmRz) | Remarks |
| Comparative | 6.7 | Inclined cutting edge ridge |
| Example 31 | | was broken |
| Example 31 | 3.1 | |
| Example 32 | 2.5 | |
| Example 33 | 1.6 | |

From Table 8, it has been found that if the PV value of the cutting edge ridge of inclined cutting edge 22 is less than or equal to 20 μm, a preferable surface roughness is obtained and high-precision cutting is possible.

(2) Verification of Curved Cutting Edge 122

(2-1) Verification of Radius r

The plurality of rotary cutting tools 1 in each of which two tips 20 were provided on base metal 10 of the fourth embodiment (FIGS. 4 and 8) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Radius R was 0.3 mm. Each of the plurality of rotary cutting tools 1 had the following roundness radius r formed by honing.

TABLE 9

| | Radius r (μm) |
|---|---|
| Comparative Example 41 | 13 |
| Example 41 | 11 |
| Example 42 | 5 |
| Example 43 | 2 |

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter.

TABLE 10

| | Workpiece surface | |
|---|---|---|
| | roughness (μmRz) | Remarks |
| Comparative Example 41 | 8.6 | Chatter occurred and surface |
| | | roughness deteriorated |
| Example 41 | 4.1 | |
| Example 42 | 3.7 | |
| Example 43 | 5.1 | |

From Table 10, it has been found that if radius r was less than or equal to 11 μm, a preferable surface roughness was obtained and high-precision cutting was possible.

(2-2) Verification of Chamfer Angle θ2

The plurality of rotary cutting tools 1 in each of which two tips 20 were provided on base metal 10 of the sixth embodiment (FIGS. 6 and 12) were prepared. The rotation diameter of outer peripheral cutting edge 23 was 6 mm. The rotation diameter of base metal 10 on the rear side of outer peripheral cutting edge 23 was 5.99 mm. The angle formed by rake surface 24, and front flank surface 26, inclined flank surface 27, and outer peripheral flank surface 28 (blade angle) was 80°. Radius R was 0.3 mm. Width W of chamfered surface 122a formed by honing was set to 0.1 mm. Each of the plurality of rotary cutting tools 1 had the following chamfer angle θ2.

TABLE 11

| | Chamfer angle θ2(°) | PV value (μm) |
|---|---|---|
| Comparative Example 51 | −4 | 2 |
| Example 51 | −5 | 3 |
| Example 52 | −15 | 1 |
| Example 53 | −25 | 1 |
| Comparative Example 52 | −30 | 2 |

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter. The surface roughness of the workpiece after cutting is shown below.

TABLE 12

| | Workpiece surface | |
|---|---|---|
| | roughness (μmRz) | Remarks |
| Comparative Example 51 | 7.4 | Inclined cutting edge ridge |
| | | was broken |
| Example 51 | 4.9 | |
| Example 52 | 4.1 | |
| Example 53 | 5.9 | |
| Comparative Example 52 | 9.1 | Deposition occurred |

From Table 12, it has been found that if the chamfer angle θ2 is −5° to −25°, a preferable surface roughness can be obtained and high-precision cutting can be performed.

Further, it has been found that the formation of chamfered surface 122a on curved cutting edge 122 tends to increase a cutting resistance, so that it is preferable to provide the roundness (radius r is less than or equal to 25 μm) by honing rather than provision of chamfered surface 122a.

(3-1) Verification of Clearance Angle of Inclined Flank Surface in Inclined Cutting Edge

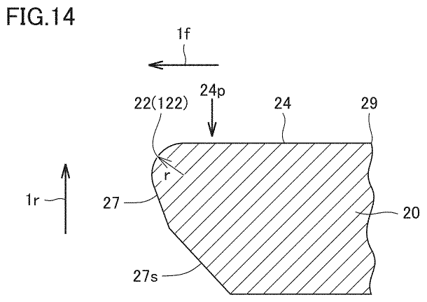

With the tool of Example 2 as a reference, inclined flank surface 27 was verified with different clearance angles. The plurality of rotary cutting tools 1 in each of which two tips 20 were provided on base metal 10 of the first embodiment (FIGS. 1 to 4) were prepared. The rotation diameter of outer peripheral cutting edge 23 was 6 mm. The rotation diameter of base metal 10 on the rear side in the rotation axis direction of outer peripheral cutting edge 23 was 5.99 mm. The angle (blade angle) formed by rake surface 24, front flank surface 26 and outer peripheral flank surface 28 was 80°. Roundness radius r formed by honing was 10 μm. Inclination angle θ1 was 45°. The clearance angle of the inclined cutting edge of each of the plurality of rotary cutting tools 1 is an angle shown in Table 13 below. When the clearance angle is small, such as 2° or 3°, a second inclined flank surface 27s (FIG. 14) was formed on the opposite side of the inclined cutting edge of inclined flank surface 27, and the clearance angle of this second inclined flank surface 27s was 10°.

FIG. 14 is a view for describing the inclined flank surface, the second flank surface, and clearance angles thereof. A direction indicated by arrow 1r is a tool rotation direction, a direction indicated by arrow 1f is a tool feed direction, and an angle formed by inclined flank surface 27 with respect to the tool rotation direction indicated by arrow 1r (parallel to an extension direction of the machined surface) is the clearance angle. When inclined flank surface 27 is small, second inclined flank surface 27s is provided.

Cutting tests were performed using the above rotary cutting tools. The cutting condition was such that peripheral speed V of outer peripheral cutting edge 23 was 200 m/min. This is high-speed cutting. The feed amount was 0.05 mm/rev. The workpiece was an iron-based sintered alloy. The prepared hole diameter was 5.8 mm. The machining allowance was 0.2 mm per diameter. Table 13 shows a circularity after cutting, and cutting edge states before and after cutting.

TABLE 13

| | Clearance | | Cutting edge state (PV | Cutting edge state (PV |
|---|---|---|---|---|
| | angle (°) of | | value of cutting edge ridge | value of cutting edge ridge |
| | inclined | Circularity | before machining of 100 | after machining of 100 |
| | cutting edge | (μm) | holes) (μm) | holes) (μm) |
| Example 61 | 2 | 4.4 | 6 | 6 |
| Example 62 | 3 | 3.1 | 5 | 6 |
| Example 2 | 10 | 1.4 | 4 | 9 |
| Example 63 | 20 | 3.7 | 6 | 15 |
| Example 64 | 22 | 4.0 | 4 | 19 |

Among evaluation results, the circularity was an average value of 10 holes from machining start. The circularity was measured using a table rotating CNC circularity/cylindrical shape measuring machine manufactured by TOKYO SEIMITSU Co., Ltd. The circularity may be less than or equal to 5 μm, more preferably less than or equal to 4 μm.

From Table 13, it has been found that if the clearance angle of the inclined cutting edge is greater than or equal to 3° and less than or equal to 20°, the circularity is in a preferable range, and a life becomes longer.

As the clearance angle becomes larger, chipping more easily occurs with an increase in the number of times of machining, and the PV value of the cutting edge ridge becomes larger, which easily deteriorates machining accuracy. Further, as the clearance angle becomes smaller, chipping is harder to occur, while the cutting resistance becomes larger and the machining accuracy easily deteriorates.

(3-2) Verification of Clearance Angle of Flank Surface in Curved Cutting Edge

With the tool of Example 42 as a reference, inclined flank surface 27 was verified with different flank angles. The plurality of rotary cutting tools 1 in each of which two tips 20 were provided on base metal 10 of the fourth embodiment (FIGS. 4 and 8) were prepared. The rotation diameter of outer peripheral cutting edge 23 was 6 mm. The rotation diameter of base metal 10 on the rear side in the rotation axis direction of outer peripheral cutting edge 23 was 5.99 mm. The angle (blade angle) formed by rake surface 24, front flank surface 26 and outer peripheral flank surface 28 was set to the same angle as the blade angle of the curved cutting edge. Radius R was 0.3 mm. Roundness radius r formed by honing was 5 μm. The clearance angle of each curved cutting edge of the plurality of rotary cutting tools 1 had an angle shown in Table 14 below. When the clearance angle is small, such as 2° or 3°, second inclined flank surface 27s was fowled on the opposite side of the curved cutting edge of inclined flank surface 27, and the clearance angle of this second inclined flank surface 27s was 10°.

Cutting tests were performed using the above rotary cutting tools. The cutting condition was such that peripheral speed V of outer peripheral cutting edge 23 was 100 m/min. This is high-speed cutting. The feed amount was 0.05 mm/rev. The workpiece was an iron-based sintered alloy. The prepared hole diameter was 5.8 mm. The machining allowance was 0.2 mm per diameter. Table 14 shows the circularity after cutting and the cutting edge states before and after cutting.

TABLE 14

| | Clearance | | Cutting edge state (PV | Cutting edge state (PV |
|---|---|---|---|---|
| | angle (°) of | | value of cutting edge ridge | value of cutting edge ridge |
| | curved cutting | Circularity | before machining of 100 | after machining of 100 |
| | edge | (μm) | holes) (μm) | holes) (μm) |
| Example 71 | 2 | 4.9 | 5 | 5 |
| Example 72 | 3 | 4.3 | 4 | 4 |
| Example 42 | 10 | 2.5 | 7 | 10 |
| Example 73 | 20 | 3.8 | 7 | 15 |
| Example 74 | 22 | 4.2 | 4 | 17 |

Among evaluation results, the circularity was an average value of 10 holes from machining start. The circularity may be less than or equal to 5 μm, more preferably less than or equal to 4 μm. From Table 14, it has been found that if the clearance angle of the curved cutting edge is greater than or equal to 3° and less than or equal to 20°, the circularity is in a preferable range and the life becomes longer.

It should be considered that the embodiments and the examples disclosed this time are illustrative in all respects, and are not restrictive. The scope of the present invention is defined not by the above-described embodiments but by the claims, and it is intended that all modifications within meaning equivalent to the claims and the scope of the claims are included.

### REFERENCE SIGNS LIST

1: rotary cutting tool, 2: rotation axis, 3: dotted line, 10: base metal, 11: groove, 12: coolant passage, 13: hole, 14: opening, 20: tip, 21: front cutting edge, 22: inclined cutting edge, 22a, 122a: chamfered surface, 23: outer peripheral cutting edge, 24: rake surface, 25: rear end, 26: front flank surface, 27: inclined flank surface, 27s: second inclined flank surface, 28: outer peripheral flank surface, 29: PCBN tip, 30: base seat, 50: brazing material layer, 122: curved cutting edge

1. A rotary cutting tool comprising:
a base metal; and
a plurality of PCBN tips provided on an outer periphery of the base metal,
wherein
each of the plurality of PCBN tips has an inclined cutting edge located at an outer peripheral forefront and forming an angle greater than or equal to 20° and less than or equal to 80° with respect to a rotation axis, and an outer peripheral cutting edge located on a rear side in a rotation axis direction of the inclined cutting edge,
a rotation diameter of the base metal on the rear side in the rotation axis direction of the outer peripheral cutting edge is smaller than a rotation diameter of the outer peripheral cutting edge,
in a cross section perpendicular to a direction in which the inclined cutting edge extends, a cutting edge ridge of the inclined cutting edge has a roundness of a radius less than or equal to 30 μm, and
a maximum height difference value of the cutting edge ridge of the inclined cutting edge is less than or equal to 20 μm.

2. The rotary cutting tool according to claim 1, wherein a clearance angle of the inclined cutting edge is greater than or equal to 3°, and less than or equal to 20°.

3. A rotary cutting tool comprising:
a base metal; and
a plurality of PCBN tips provided on an outer periphery of the base metal,
wherein
each of the plurality of PCBN tips has a curved cutting edge located at an outer peripheral forefront and having an inclination to a rotation axis varied, and an outer peripheral cutting edge located on a rear side in a rotation axis direction of the curved cutting edge,
a rotation diameter of the base metal on the rear side in the rotation axis direction of the outer peripheral cutting edge is smaller than a rotation diameter of the outer peripheral cutting edge,
in a cross section perpendicular to a direction in which the curved cutting edge extends, a cutting edge ridge of the curved cutting edge has a roundness of a radius less than or equal to 11 μm, and
a maximum height difference value of the cutting edge ridge of the curved cutting edge is less than or equal to 20μm.

4. The rotary cutting tool according to claim 3, wherein a clearance angle of the curved cutting edge is greater than or equal to 3°, and less than or equal to 20°.

5. The rotary cutting tool according to claim 1, wherein a maximum height difference value of a cutting edge ridge of the outer peripheral cutting edge is less than or equal to 20 μm.

6. The rotary cutting tool according to claim 1, wherein a difference between the diameter of the base metal on the rear side in the axial direction of the outer peripheral cutting edge and the rotation diameter of the outer peripheral cutting edge is greater than or equal to 0.01 mm, and the diameter of the base metal on the rear side in the axial direction of the outer peripheral cutting edge is larger than 50% of the rotation diameter of the outer peripheral cutting edge.

7. The rotary cutting tool according to claim 3, wherein a maximum height difference value of a cutting edge ridge of the outer peripheral cutting edge is less than or equal to 20 μm.

8. The rotary cutting tool according to claim 3, wherein a difference between the diameter of the base metal on the rear side in the axial direction of the outer peripheral cutting edge and the rotation diameter of the outer peripheral cutting edge is greater than or equal to 0.01 mm, and the diameter of the base metal on the rear side in the axial direction of the outer peripheral cutting edge is larger than 50% of the rotation diameter of the outer peripheral cutting edge.
